(19) United States
(12) Patent Application Publication
(10) Pub. No.: US 2010/0325057 A1
(43) Pub. Date: Dec. 23, 2010

(54) LEVERAGING SOCIAL CAPITAL ON A WEBSITE

(75) Inventor: Kamal Jain, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/486,090

(22) Filed: Jun. 17, 2009

(51) Int. Cl. G06Q 99/00

(52) U.S. Cl. 705/319; 705/35

(57) ABSTRACT

The described techniques relate to leveraging social capital associated with a user's profile on a website. In some implementations, a framework can be provided that includes a protected space associated with the user's profile on a social networking website. The protected space can be configured to allow verified indicia of the social capital to be posted thereon.

### BACKGROUND

Digital social networking sites, such as FACEBOOK for example, are becoming ever more popular around the world. These sites offer a relatively easy way for users sharing common interests to communicate with one another. To accomplish this, social networking sites can digitally map social networks in which these users can be linked.

One advantage of digital social networking sites is their ease of use and the freedom of expression they offer. Stated in the extreme, typically anyone can post almost anything on such a site. In the context of individual users, these users can create a user profile on a social networking site and have almost unrestrained freedom with respect to the information they post to characterize themselves or other users in their social network. This level of freedom, however, can also limit the extent by which the value of these sites can be leveraged.

### SUMMARY

This patent application relates to leveraging social capital. For instance, the social capital can be associated with a user's profile on a website, such as a social networking website. The social capital can be based on one or more characteristics of individual members and/or their relationships within the user's social network.

In some implementations, a framework that includes a protected social capital space (SCS) can be associated with the user's profile on the website. For example, the protected SCS may be presented as a so called “wall” on a social networking website, for instance. In at least one implementation, an entity other than the user can oversee the authenticity of the protected SCS. This authentication can increase the value of social capital and allow social capital to be leveraged in ways that are not practical in existing scenarios.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIG. 1 illustrates an example system in which the described social capital leveraging techniques can be implemented, in accordance with some implementations.

FIG. 2 illustrates an example social capital module, in accordance with some implementations.

FIG. 3 illustrates an example presentation of a social capital space, in accordance with some implementations.

FIG. 4 illustrates a flowchart of an example social capital leveraging method, in accordance with some implementations.

### DETAILED DESCRIPTION

### Overview

This patent application relates to leveraging social capital. For instance, the social capital can be associated with a user's profile on a website, such as a social networking website. The social capital can be based on one or more characteristics of individual members and/or their relationships within the user's social network.

In some implementations, a framework that includes a protected social capital space (SCS) can be associated with the user's profile on the website. For example, the protected SCS may be presented as a so called “wall” on a social networking website, for instance. In at least one implementation, an entity other than the user can oversee the authenticity of the protected SCS. This authentication can increase the value of social capital and allow social capital to be leveraged in ways that are not practical in existing scenarios.

In some implementations, the protected SCS can be protected in various ways. For example, the protected SCS can be protected from unauthorized posting of indicia or other modifications to the SCS. As another example, steps can be taken to prevent, or help to prevent, the user's profile from being closed or disassociated from the user, and/or to prevent the user from opening another user profile. In addition to being protected, the protected SCS can be verified by ensuring or confirming that indicia to be posted on the SCS is accurate and/or authentic.

By virtue of the protection and verification of the protected SCS, the protected SCS can be relied upon as a trustworthy forum by which indicia associated with social capital can be posted and/or used to attribute a value to the social capital. This may allow for the social capital to be leveraged as an asset and/or increase the value attributed to the social capital. For example, posting negative indicia that could influence the social capital's value, or the option of posting such indicia, may be perceived by a third party as being a valuable way to leverage the social capital. As another example, because of the trustworthy nature of the protected SCS, more credence may be given by the third party to posted indicia, whether it be positive or negative, as a basis for attributing a value to the social capital. In addition, more credence may also be given by the third party to a lack of negative posted indicia—which may increase the perceived value of the social capital. This can benefit the third party and the user, one or both of which may be willing to pay the website to make use of the protected SCS.

In some implementations, value-related functions can be performed with respect to the social capital. For example, a value can be attributed to the social capital by utilizing one or more parameters to calculate the value. In some implementations, information describing one or more characteristics of the user's social network may be used, or considered for use, as a parameter(s). As another example, since a perceived value can be calculated for the social capital, some implementations, can use the social capital as collateral (i.e., social collateral) to secure a loan. As such, the extent by which the social capital has been collateralized (e.g., already used as collateral for) can be tracked. Furthermore, in some implementations, the value of the social capital and/or extent of its collateralization may be posted as indicia on the protected SCS.

Multiple and varied implementations are described below. Generally, any of the features/functions described with reference to the figures can be implemented using software, hardware, firmware (e.g., fixed logic circuitry), manual processing, or any combination thereof. The term “software” as used herein generally represents any computer-readable code or other instructions and can include, without limitation, software applications, middleware, system software, etc., that can be stored on computer-readable media, and that when executed or otherwise implemented, provide functionality. The computer-readable media can include, without limitation, all forms of volatile and non-volatile memory and/or storage media. Such media can include ROM, RAM, flash memory, hard disk, removable media, and the like.

The term, “module” or “component” as used herein generally represents software, hardware, firmware, or any combination thereof. For instance, the term”“module” or “component” can represent software code and/or other types of instructions that perform specified tasks when executed on a computing device or devices. These instructions may be stored on one or more computer readable media. Generally, the illustrated separation of modules, components and functionality into distinct units may reflect an actual physical grouping and allocation of such software, firmware, and/or hardware. Alternatively or additionally, this illustrated separation can correspond to a conceptual allocation of different tasks to the software, firmware, and/or hardware. The illustrated modules, components and functionality can be located at a single site (e.g., as implemented by a computing device), or can be distributed over multiple locations (e.g., as implemented by multiple computing devices).

### Example System

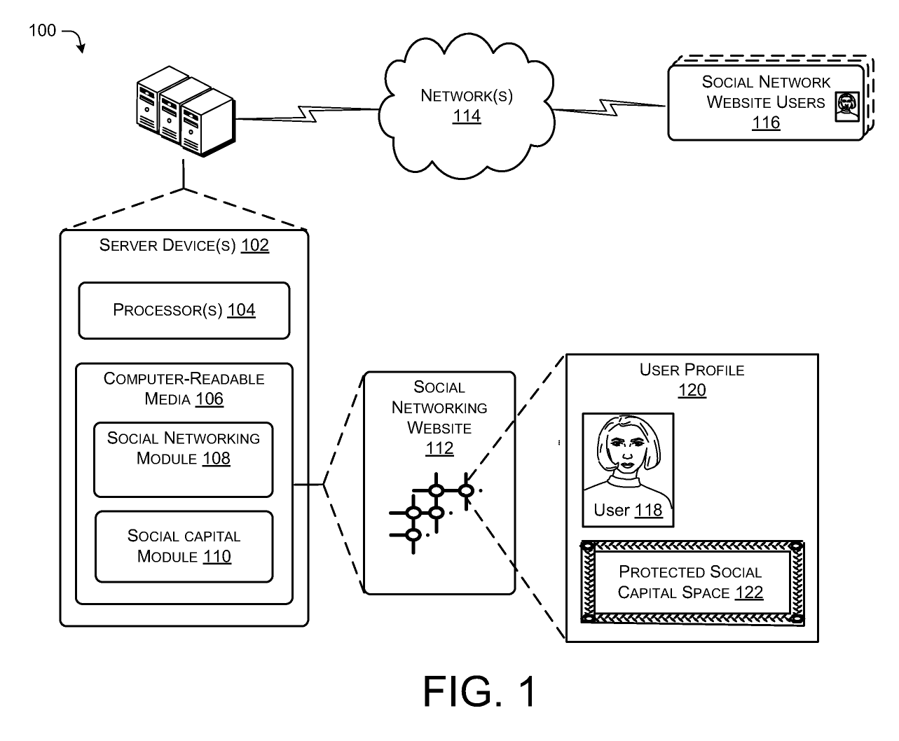

FIG. 1 illustrates an example system, generally at 100, in which the described social capital leveraging techniques can be implemented. Here, system 100 includes one or more server devices 102. Server device(s) 102 may be implemented as any number of suitable computing devices. For example, server device(s) may include: dedicated servers, desktop computers, laptops or portable computers, mainframe computers, or the like. Server device(s) 102, in turn, includes one or more processors 104 and one or more computer-readable media 106 on which one or more computer-readable instructions can reside, and which are executable by processor(s) 104. Computer-readable media 106 can include, without limitation, all forms of volatile and non-volatile memory and/or storage media that are typically associated with a computing device. Such media can include ROM, RAM, flash memory, hard disk, removable media, and the like.

In this example, server device(s) 102 includes a social networking module 108 and a social capital module 110, both of which are executable by processor(s) 104. For purposes of discussion, social networking module 108 and social capital module 110 are illustrated as being separate modules. However, in other configurations all or part of these modules may be integrated as a single module. Furthermore, in those implementations where these modules are separate modules, the described functionality may be performed by either module, or by any combination of these modules.

Social networking module 108 can provide a social networking website 112 which, via one or more networks 114, may be accessed by any number of social network website users (SNWUs) 116. Network(s) 114 may include any number of wired and/or wireless networks such as one or more local area networks (LANs), one or more wide area networks (WANs) (e.g., the Internet), or the like.

Social networking website 112 can digitally map one or more social networks that include members (social entities such as persons and/or institutions for example) and one or more ties or relationships between individual members. In this regard, social networking website 112 can provide a framework in which SNWUs 116 may create and own user profiles, join one or more of the mapped social networks as a member, interact with other members, and/or view information about various members and their relationships with members and/or other social entities. By creating a user profile, joining a social network(s), and interacting with other social entities, an individual user can effectively establish a social identity that others recognize and associate with the individual user's profile.

One example SNWU 116 is shown here as user 118. For purposes of discussion, assume that user 118 has created, and is thus the owner of, a user profile 120 on social networking website 112. Also assume that user 118 has joined a social network (hereinafter the “user's social network”) as a social entity and member of the group. For purposes of illustration, user 118 is shown here as a person. However, it is to be appreciated and understood that user 118 may be any type of entity such as, without limitation, an institution such as a business, charity, or the like without deviating from the spirit and scope of the claimed subject matter.

Social capital module 110 can provide a framework in which the described techniques for leveraging the social capital of individual user profiles, including the social capital of user profile 120, can be implemented. For example, in some implementations, social capital module 110 can provide a protected or authenticated social capital space (protected SCS) 122 associated with user profile 120. Protected SCS 122 can be any suitable forum or space, such as a so called “wall” for example, on which indicia of the user's social capital may be posted. By way of example and not limitation, indicia may include text, digital accolades or certificates, values (e.g., a value attributed to the social capital), sound media, video media, and/or any other type of digital information describing or otherwise associated with the user's social capital.

Here, protected SCS 122 is shown as being presented with user profile 120, as it may be presented on social networking website 112. However, protected SCS 122 may be presented in any suitable way on social networking website 112 such that it can be viewed or otherwise discovered by others.

Social capital module 110 can protect the protected SCS 122 in various ways. For example, social capital module 110 may regulate any modification to protected SCS 122, including the posting of indicia on the protected SCS or the modification of posted indicia. Additionally or alternatively, social capital module 110 may prevent, or help to prevent, user profile 120 from being closed and/or from being disassociated with or from user 118. In some implementations, social capital module 110 may also prevent user 118 from creating or maintaining another user profile on social networking website 112 and/or another website. In this regard, user 118 might contractually agree to these protective conditions, such as via a user's agreement when creating user profile 120 and/or a business agreement (e.g., loan application) for instance.

Social capital module 110 can also verify protected SCS 122 by ensuring or confirming that indicia to be posted on protected SCS 122 is accurate and/or authentic. Additionally or alternatively, social capital module 110 may ensure or confirm that other information not to be posted on protected SCS 122—but associated with the social capital—is accurate and/or authentic. One example of such information might be unposted data describing the user's social network.

In addition to protecting the protected SCS 122 and verifying indicia to be posted, social capital module 110 can also perform various value-related functions. For example, social capital module 110 may attribute a value to the social capital by utilizing one or more parameters to calculate the value. In some implementations, verified information describing the user's social network can be used as a parameter(s), or used to derive a parameter(s). As another example, social capital module 110 may track and account for the collateralization of the social capital. Put another way, a running balance of the extent by which the social capital has been collateralized may be kept by social capital module 110. In some implementations, the results of these value-related functions (e.g., an indication of the social capital's value and/or the remaining balance of the social collateral) may be posted on protected SCS 122.

### Example Environment

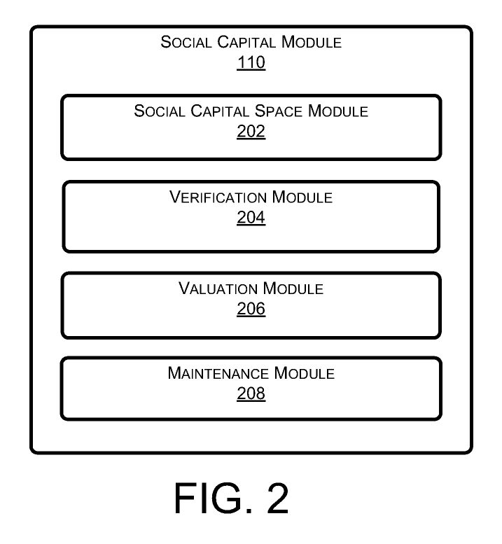

To assist the reader in appreciating functionality provided by social capital module 110, FIG. 2 illustrates a detailed view of this module. Like numerals from FIG. 1 have been utilized to depict like components. However, FIG. 2 illustrates but one example of a social capital module and is thus not to be interpreted as limiting the scope of the claimed subject matter.

In this example, social capital module 110 includes a SCS module 202 which can be configured to present or otherwise provide protected SCS 122 on social networking website 112. SCS module 202 can also be configured to protect or secure protected SCS 122 by limiting access of protected SCS 122 to authorized entities (i.e., restricting unauthorized access of protected SCS 122). This can be accomplished in any suitable way. For example, in some implementations, SCS module 202 may require that an entity be authenticated before being granted full or partial access to protected SCS 122. Full access may include access to post indicia and/or to modify (change or delete) posted indicia. Partial access may be some level of access that is less than full access (e.g., access to post indicia but not modify posted indicia, access to only modify certain types of posted indicia, etc.).

In operation, one or more entities (hereinafter “the SCS control entity”) other than user 118 may be solely responsible for authorizing access to protected SCS 122. For instance, social networking site 112 may function as the SCS control entity. Put another way, the SCS control entity may have sole control and thus discretion to identify entities as having authority to access protected SCS 122. In addition, in some implementations, the SCS control entity may have sole responsibility for, and control of, decisions, policies, and/or other factors associated with the maintenance and operation of social networking website 112 (and thus social networking module 108 and social capital module 110).

In some other implementations, more than one entity may be granted full or partial access to protected SCS 122 after authenticating with SCS module 202. In this regard, the SCS control entity may be ultimately responsible for determining which entities are authorized to authenticate with SCS module 202, and for the level of access assigned to individual authorized entities.

In addition to regulating access to protected SCS 122, SCS module 202 can also be configured to prevent user 118 from closing user profile 120 or otherwise becoming disassociated with user profile 120. For example, SCS module 202 may disable functionality that allows user 118 (or any other entity except the control entity) to remove user profile 120 from social networking website 112 or to change user profile 120 to be associated with another owner.

SCS module 202 can also be configured to prevent, or assist in preventing, user 118 from creating or maintaining another user profile on social networking website 112. This can be accomplished in any suitable way. For example, in some implementations, SCS module 202 may utilize heuristic and/or algorithmic techniques to prevent (or assist another entity such as the SCS control entity to prevent) user 118 from creating a new profile. Alternatively or additionally, SCS module 202 may identify, or assist in identifying, existing suspicious user profiles on social networking website 112 that may have been opened by user 118. Consider, for instance, a scenario where user 118 attempts to open a new user profile using a derivation of their name (e.g., Bob. Cooper vs. Robert James Cooper).

Furthermore, in some implementations, SCS module 202 can also be configured to assist the control entity and/or a third party (e.g., a lender) to discover user profiles created by user 118 on another website. As will be appreciated and understood by those skilled in the art, this can be accomplished in any suitable way, such as by using Internet search tools and techniques for instance. In certain situations, such as where user 118 has taken out a loan using the social capital as social collateral, discovering this information may be very important to the third party since user 118 may have contractually agreed not to potentially dilute the social capital's value as social collateral by also using it on another website.

Social capital module 110 also includes a verification module 204. Verification module 204 can be configured to verify, or assist in verifying, that indicia to be posted on protected SCS 122 is accurate and/or authentic. Additionally or alternatively, verification module 204 may verify that other information (not to be posted) associated with the social capital (e.g., information describing the user's social network) is accurate and/or authentic.

For example, in some implementations, verification module 204 may confirm the identity of a third party submitting indicia to be posted on protected SCS 122. If the identity of the third party is confirmed, the submitted indicia may be assumed to be accurate and/or authentic. In this regard, the third party's identity can be confirmed by verification module 204 in any suitable way, such as by querying SCS module 202 and/or the control entity for instance.

Alternatively or additionally, verification module 204 may analyze submitted indicia or metadata accompanying the submitted indicia to determine whether the indicia is accurate and/or authentic. This may be accomplished in any suitable way. For example, the verification module 204 may utilize heuristic and/or algorithmic techniques to analyze the indicia and/or metadata to identify a watermark or other characteristic feature for instance. As another example, the verification module 204 may search, or assist in searching, various sources (e.g., the U.S. Patent & Trademark Office Website if the indicia is a trademark) to confirm the indicia's accuracy and/or authenticity.

Verification module 204 may, in some implementations, allow the third party to register for and maintain a bank of stored indicia in a protected storage of social networking website 112. At the third party's request, and/or by the third party authenticating with social capital module 110, one or more of the indicia may be posted on protected SCS 122.

By virtue of the above described protection and verification, protected SCS 122 can be relied upon as a trustworthy forum by which indicia associated with the user's social capital can be posted and/or used to attribute a value to the social capital. This may allow for the user's social capital to be leveraged as an asset and/or may increase the value attributed to the user's social capital. This can benefit the third party and the user, one or both of which may be willing to pay social networking website 112 to make use of protected SCS 122.

More particularly, because of the trustworthy nature of protected SCS 122, more credence may be given by a third party to posted indicia (whether it be positive or negative) as an indicator of the user's social collateral value. In addition, more credence may also be given by the third party to a lack of negative posted indicia—which may increase the perceived value of the user's social capital. This is because the third party can be provided with assurance that user 118 has not simply closed a previous user profile and opened user profile 120, modified or removed posted negative indicia, or posted fraudulent positive indicia.

Furthermore, because of the trustworthy nature of protected SCS 122, the ability to post (and/or the threat to post) negative indicia can add further value to the protected SCS. For instance, a third party may be interested in this feature. As a practical example, consider a scenario where the third party is a lender. The lender's perceived value in the user's social capital will likely influence the chances of user 118 securing a loan using the social capital as social collateral and/or of the loan having a more attractive rate of interest. In this regard, the lender may wish to consider the option of posting indicia on protected SCS 122. As noted above, the trustworthy nature of protected SCS 122 will likely increase the lender's confidence that any indicia it chooses to post will remain accurately presented on protected SCS 122. In this way, the user's social capital can be effectively leveraged.

The user's social capital can be leveraged in other ways as well. For example the user's social capital can be leveraged by the lender to induce user 118 to make loan payments. More particularly, by posting a potentially embarrassing late loan payment message (i.e., negative indicia), peer pressure from members of the user's social group (or others) may induce user 118 to make the loan payment. As such, this option may increase the value that the lender attributes to the user's social capital since the potential peer pressure effectively decreases the chance user 118 will default on a loan. Since the value attributed by the lender may be increased, the chances of user 118 securing the loan and/or of the loan having a more attractive rate of interest may be increased.

The trustworthiness of protected SCS 122 may also provide value with respect to posting indicia to praise or otherwise recognize user 118, and/or as an advertisement (e.g., a trademark). For example, a third party may want to post a digital accolade or other type of recognition of user 118 on protected SCS 122. By virtue of the trustworthy nature of protected SCS 122, the recognition will likely be given more credence by members of the user's social network or any others that discover it. This may benefit the third party and user 118, one or both of which may be willing to pay the social networking website 112 to make use of protected SCS 122 in this manner.

In some cases. the secure nature of protected SCS 122 can be beneficial to both a third-party and the user in what can be thought of as a symbiotic manner. For instance, say a university that the user attended wants to add a new building. The user can donate money to build the building. In a traditional scenario unless the user is a major contributor the user's donation is likely to go largely unrecognized.

The present concepts offer a way for the user to receive accolades for his/her donation that may, in fact, make it more likely that the user will make the donation. For instance, the university can request a donation from the user and indicate that a recognition of any donation will be made on the user's protected SCS 122. Upon receipt of the donation, the university can request that the SCS control entity place a plaque or other accolade on the user's protected SCS in recognition of the donation. The SCS control entity may charge the university some fee for the posting and/or for verifying the university is actually the ‘university’ and that the donation actually occurred. The user, while not necessarily motivated by a desire for recognition may be motivated to donate when he/she will be recognized for the donation. Beyond the user's protected SCS, the SCS control entity may verify and/or support the accolade being carried in a newsfeed from the university, such as in an alumni e-newsfeed. As an added benefit either of these scenarios is likely to be noticed by the user's friends who also attended the university and incentivize them to donate. Of course, similar scenarios can relate to other types of giving whether monetary or time-based.

In another example the present concepts can contribute to environmental conservation. For instance, assume that a local utility company gives accolades on protected SCSs for those whose energy bill is among say the lowest 10 percentile of households of a particular size. Users can vie for the rewards and thereby decrease energy consumption. The SCS control entity can charge the utility company for the postings. Alternatively or additionally, the SCS control entity may profit from linking the accolades to advertisements for energy efficient products etc. Some regions also offer consumers the option of paying extra for green energy. An accolade can be posted on the user's protected SCS for selecting green energy. Such an accolade based on the user's actual energy bill, can incentivize the user to buy cleaner energy (since the utility company may account for the type of energy the user is buying, when giving the accolade).

Several examples of positive accolades and how positive accolades can promote positive behavior are described above. Still other examples of positive accolades can include accolades for doing well on homework etc, helping a friend in school, and other good karmas, which could be posted on a students' protected SCS. Even kindergartners can have social network profiles, such as on Webkinz. Currently, schools can employ giving cards, or girls scout gives stickers to be stitched on the girl's scout jacket, etc. However, such recognition can only be appreciated by people that actually see the child. The present concepts are both independent of physical proximity and are verified and as such offer advantages over existing technologies.

As explained above, in addition to protecting the protected SCS 122 and verifying indicia to be posted, social capital module 110 can also perform various value-related functions, such as attributing a value to the user's social capital. Accordingly, here social capital module 110 includes a valuation module 206. Valuation module 206 can be configured to attribute a value to the user's social capital by utilizing one or more parameters to calculate the value. This value can be any type of indication (e.g., number, ranking, etc.,) and can be expressed in, or otherwise associated with, any suitable unit or units (e.g., dollars, pre-defined units, points, etc.). In this regard, valuation module 206 may employ one or more heuristic and/or algorithmic techniques to calculate or otherwise determine the value based on the one or more parameters.

As a practical example, in the context of using the user's social capital as social collateral for a loan, consider a scenario where a lender or a group of lenders provides (or otherwise agrees to) a social capital algorithm. If user 118 also approves the social capital algorithm, valuation module 206 may employ the trusted or approved social capital algorithm to calculate a trusted social capital value that both the lender(s) and user 118 agree may be used as social collateral. In this regard, the algorithm may be configured to utilize one or more agreed-upon parameters for the calculation.

With respect to the one or more parameters, any suitable parameter information may be used as a parameter, or to derive a parameter. In some implementations, information describing one or more characteristics of the user's social network may be used, or considered for use. Without limitation, this may include information describing: the structure of the user's social network (e.g., number of members, age of user profiles for individual members, etc.), the age of various individual relationships between individual members of the social network (e.g., the length of time members have been linked in the social network), the nature of individual relationships (e.g., relative, co-worker, friend, etc), the level of activity associated with individual relationships (e.g., amount and/or frequency of communication between individual members), and/or attributes of individual members (credit rating, age, length of employment, etc.). As noted above, this information may or may not be posted (or submitted to be posted) on protected SCC 122.

As one example, consider a scenario where parameter information describes a credit rating attribute of a member of the user's social network (thus linked to user 118 and user profile 120). If the member's credit rating is considered to be neutral or positive in nature, an algorithm may be employed that is configured to treat this attribute as a positive parameter when calculating a value for the user's social capital. However, if the credit rating is considered to be negative in nature, the algorithm may be configured to ignore this attribute as a parameter—rather than treating it as a negative parameter.

As another example, valuation module 206 may determine whether or not to consider an individual member of the user's social network with respect to calculating the value. Consider a scenario for instance where user 118 and the member are only directly linked to one another in the social network. Put another way, in this scenario the member and user 118 are not indirectly linked to one another via any other members. As such, valuation module 206 may determine that the relationship between the certain member and user 118 is suspicious and should be further investigated. Furthermore, once identified as suspicious, the relationship to the member may be given less or no weight when calculating the user's social capital value. This may be accomplished in any suitable way, such as by algorithmic and/or heuristics techniques. Furthermore. these techniques may utilize any suitable criteria to identify a suspicious member/relationship.

Since the user's social capital can be associated with a perceived and/or calculated value, in some circumstances the user's social capital may be used in a manner similar to other assets. As such, and as noted above, the user's social capital can be used as social collateral by user 118 to secure or help secure a loan. One example of this was described above in the example of the third party lender.

As a way of monitoring the usage of the user's social capital as social collateral, here social capital module 110 includes a maintenance module 208. Maintenance module 208 can be configured to track the extent by which the user's social capital has already been collateralized (i.e., the user's social capital collateralization). This can be accomplished in any suitable way. For example, in some implementations, maintenance module 208 can utilize a user's social capital value that has been attributed to the user's social capital (e.g., by valuation module 206) as a starting social collateral value (SSCV). When a portion of the SSCV (equal to or less than the SSCV) is used as collateral for a first loan, maintenance module 208 can subtract that portion from the SSCV to derive a remainder value. This remainder value can then be identified as the available social collateral for a subsequent loan. This arithmetic function may be repeated any number of times as a way to track the use of the user's social capital as social collateral.

As a practical example of a SSCV, consider the above discussion of the trusted social capital algorithm. Recall that by virtue of both the lender(s) and user 118 agreeing to the trusted social capital algorithm, the trusted social capital algorithm could be used to calculate a trusted social capital value that both the lender(s) and user 118 presumably agreed may be used as social collateral. In some implementations, this trusted social capital value may be used as the SSCV.

In some implementations, indicia associated with the calculated social capital value and/or the social collateral described above may be posted on protected SCS 122. This may include the calculated value and/or a representation of the value (e.g., a graph, chart, status bar, etc.), the amount (and potentially other details) of any loans already secured by user 118 using the social capital, the extent of the social capital's collateralization (e.g., a graph, chart, status bar, etc.), and/or any other information associated with the social capital being used as social collateral.

### Example Protected Social Capital Space

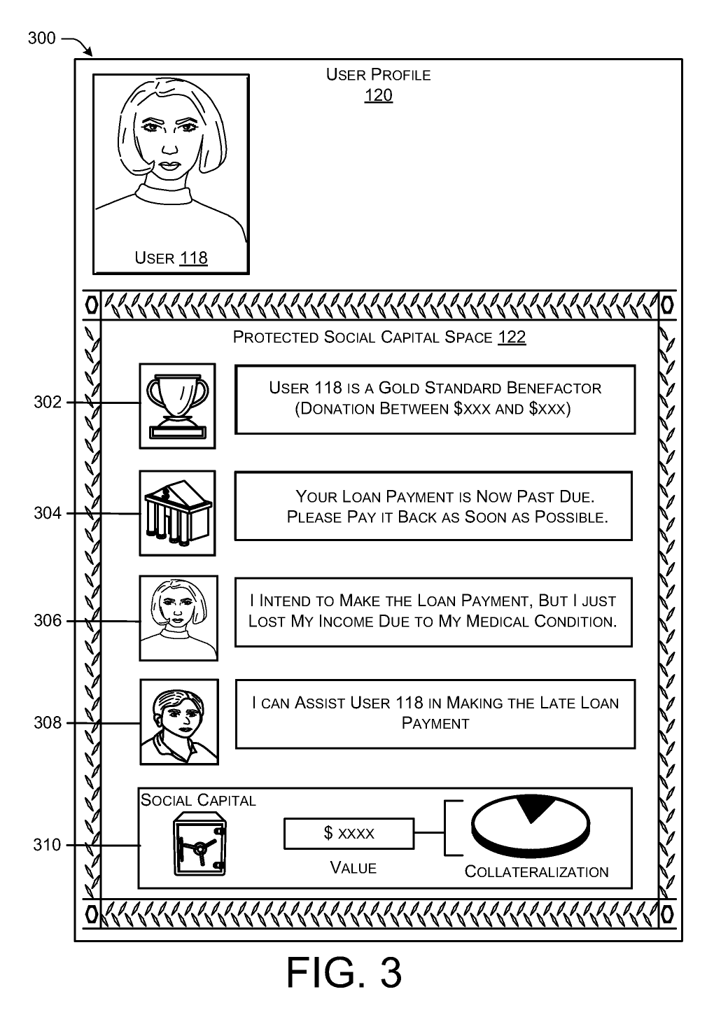

FIG. 3 offers an example of a website presentation 300 in which protected SCC 122 can be presented. Here, protected SCS 122 is presented with user profile 120 in website presentation 300. In this example, user 118 is shown as being the owner of user profile 120. As noted above however, protected SCS 122 may be presented in any number of other ways on social networking websites without deviating from the course and scope of the claimed subject matter.

In this example, protected SCS 122 is shown as including several posted indicia associated with the social capital of user profile 120. These indicia are but examples of possible types of indicia. As such, any suitable type of digital information may be used as indicia. For example, as explained above, this may include text, digital accolades or certificates, values (e.g., a value attributed to the user's social), sound media, video media, etc.

More particularly, here protected SCS 122 includes indicia 302 which is a digital accolade that has been posted on the protected SCS. In this example, the digital accolade includes a symbol depicting a trophy representing a recognition inferred on user 118. Furthermore, in addition to including the symbol of the trophy, indicia 302 may include a text message which can be used to provide further context or meaning to indicia 302. For example, assume here that the third party posting indicia 302 is a charity organization. As such, indicia 302 includes a text message indicating that user 118 is a “Gold Standard Benefactor” and thus has donated a certain amount of money to the charity (“Between $xxx and $xxx). While here the trophy and text message of indicia 302 is presented generically, the charity posting this indicia may, in some implementations, choose to provide a trademark or other indication of their identity (e.g., an advertisement) with or instead of the digital symbol.

As explained above, the option of posting indicia can provide value to a third party, user 118, and/or social networking website 112. For instance, by posting indicia 302, the charity has recognized user 118 in a manner that allows anyone that discovers protected SCS 122 (e.g., other members of the user's social network) to recognize user 118 as a benefactor. This may benefit user 118 by increasing his or her social capital. Further, this may benefit the charity by providing user 118 with an incentive to make donations to the charity. Further still, by virtue of these benefits, the third party, user 118, and/or another entity may be willing to pay social networking website 112 to make use of protected SCS 122.

Presentation 300 also includes indicia 304, which is a message posted on protected SCS 122 by a third party. More particularly, and for purposes of discussion, assume that this third party is a lender that has made a loan to user 118. As described above, by posting a potentially embarrassing late loan payment message, peer pressure can be induced on user 118 to make the loan payment. Here indicia 304 provides an example of such a message. More particularly, indicia 304 includes a symbol identifying the lender (here shown as a generic symbol of a bank building) as well as text of the potentially embarrassing message (“Your Loan Payment is Now Past Due. Please Pay it Back as soon as Possible.”).

In addition to indicia 302 and 304, presentation 300 also includes posted indicia 306 which, in this example, includes a reply message from user 118 responding to posted indicia 304. More particularly, indicia 306 includes a symbol identifying user 118 as well as the text of the reply message (“I Intend to Make the Loan Payment, But I just Lost My Income Due to my Medical Condition.”). By virtue of being able to provide an explanation to the potentially embarrassing message of indicia 304, value can be provided to both the lender and user 118. More particularly, the lender can be provided with valuable information with respect to assessing which steps to take to address the late loan payment. User 118, in turn, can be provided with the opportunity to explain his or her circumstances. This may help mitigate the loss of the user's social capital that will likely occur due to the posting of indicia 304 (i.e., the potentially embarrassing message).

In this example, presentation 300 also includes posted indicia 308 which includes a message from a third party other than the charity or lender above. For purposes of discussion, assume here that this third party is a member of the user's social network (e.g., a friend of user 118) that has discovered protected SCS 122 and learned of the late loan payment. Here, this member has decided to post indicia 308 which includes a symbol identifying the member as well as a text message indicating that he or she is willing to help user 118 make the late loan payment (“I can Assist User 118 in Making the Late Loan Payment”).

Finally, as noted above, indicia associated with the calculated social capital value and/or the social collateral described above may be posted on protected SCS 122. As such, in this case posted indicia 310 includes a symbol (a vault) and a label (“Social Capital) identifying that information associated with the social capital is posted. In addition, indicia 310 includes a value attributed to the social capital (“$xxxx”) and a pie chart visually depicting the extent by which the social capital has been collateralized (the darkened slice). Since the value-related functions may be performed at any frequency, indicia 310 can be periodically updated at any suitable frequency.

### Method Example

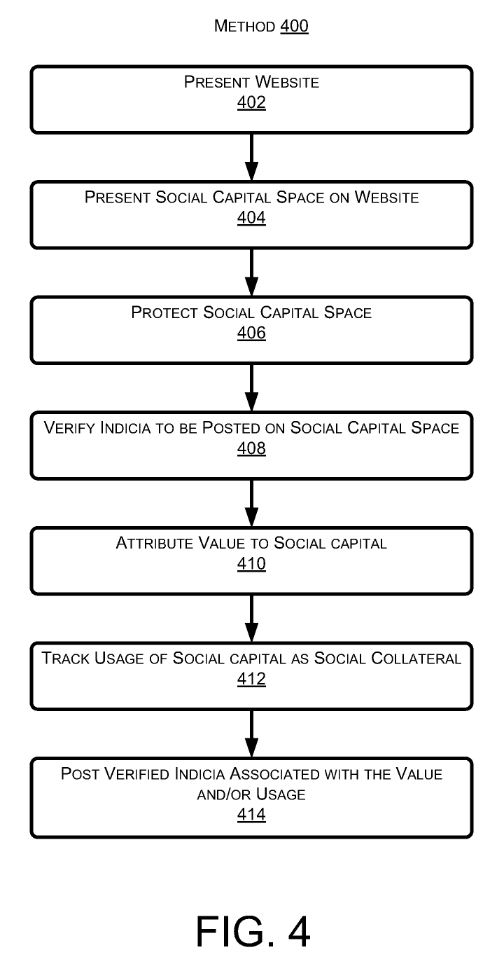

FIG. 4 shows a flowchart of a social capital leveraging method 400 that is consistent with at least some implementations of the described concepts and techniques. The order in which the method is described is not intended to be construed as a limitation, and any number of the described blocks can be combined in any order to implement the method, or an alternate method. Furthermore, the method can be implemented in any suitable hardware, software, firmware, or combination thereof, such that a computing device can implement the method. In one case, the method is stored on a computer-readable storage media as a set of instructions such that execution by the computing device causes the computing device to perform the method.

At block 402 the method can present or otherwise provide a website. In some implementations, such as those illustrated and described above, the website can be a social networking website (e.g., social networking website 112). The website may digitally map one or more social networks consisting of members and various relationships between individual members. An individual user of the website may create and own a user profile and thus be digitally identified or represented on the website as a member of one or more of the social networks. The user may be a single person, multiple persons, and/or an institution.

At block 404, the method can present or otherwise provide a SCS on the website. This space can be associated with the user's profile on the website. One example of such a space is protected SCS 122 illustrated and described above. As noted above, in some implementations, the SCS may be a so called “wall” on a social networking website.

At block 406 the method can protect the SCS (i.e., protected SCS). This can include taking various measures to ensure that the user remains associated with, and represented by, the user profile. Put another way, measures may ensure that the user's digital identity or representation remains tied to the user profile. Protecting the SCS can also include ensuring that indicia associated with the social capital of the user, and thus the user's profile, is not posted on the protected SCS in an unauthorized manner. In addition, protecting can also include ensuring that posted indicia on the protected SCS is not modified (e.g., changed or removed) in an unauthorized manner. As noted above, in some implementations a trusted central control entity may be responsible for any policies or decisions regarding the protection. As such, third parties can be provided with assurance that posted indicia accurately represents the social capital.

At block 408, the method can verify indicia to be posted on the SCS. More particularly, the authenticity and/or accuracy of indicia to be posted on the SCS can be ensured or confirmed before it is posted. As noted above, in some implementations, the trusted central control entity may be responsible for any policies or decisions regarding the verification. As such, third parties can be provided with further assurance that posted indicia accurately represents the social capital.

At block 410, the method can attribute a value to the social capital. As noted above, in some implementations, the value may be based on one or more parameters. For example, and as described above in detail in the context of protected SCS 122, a parameter(s) describing or otherwise associated with the user's social network may be utilized. The value can be any type of indication (such as described above in the context of protected SCS 122 for example) and can be expressed in, or otherwise associated with, any suitable unit or units (such as described above in the context of protected SCS 122 for example). In this regard, one or more heuristic and/or algorithmic techniques may be utilized to calculate or otherwise determine the value utilizing the parameter(s). At block 412, the method can track the usage of the social capital as social collateral. This can be accomplished in any suitable way. For example, as described above in the context of protected SCS 122, a SSCV can be used as the basis for an arithmetic function for calculating an available social collateral value after each use of the social capital as social collateral for a loan.

At block 414, the method can post verified indicia associated with the value and/or usage described at blocks 410 and 412 above, respectively. Examples of this are illustrated and described above, such as with FIG. 3 and the accompanying discussion.

### Conclusion

Although techniques, methods, devices, systems, etc., pertaining to utilizing a protected and verified social capital space to leverage social capital are described in language specific to structural features and/or methodological acts, it is to be understood that the subject matter defined in the appended claims is not necessarily limited to the specific features or acts described. Rather, the specific features and acts are disclosed as exemplary forms for implementing the claimed methods, devices, systems, etc.

1. A system comprising:
a social networking module configured to present a website comprising a user profile associated with a social network;
a verification module configured to verify indicia associated with social capital of the user profile, wherein the social capital is based at least in part on at least one characteristic of the social network; and,
a space module configured to provide, on the website, a protected space associated with the user profile, wherein the protected space is controlled by a control entity other than an owner of the user profile and is configured to present verified indicia of the social capital.

2. The system of claim 1, wherein the website comprises a social networking website configured to digitally map the social network.

3. The system of claim 1, further comprising a valuation module configured to attribute a value to the social capital by utilizing one or more parameters associated with the at least one characteristic of the social network.

4. The system of claim 1, wherein the at least one characteristic describes one or more of:
a structure of the social network;
an age of individual relationships between members of the social network;
a nature of individual relationships between members of the social network;
a level of communicative activity between members of the social network; or
one or more attributes of individual members of the social network.

5. The system of claim 1, wherein the verified indicia of the social capital comprise one or both of a symbol or text message provided by a party other than the owner of the user profile.

6. The system of claim 1, wherein the space module is configured to limit access of the protected space to authorized entities identified by the control entity.

7. One or more computer-readable storage media having instructions stored thereon that when executed by a computing device cause the computing device to perform a method comprising:
verifying indicia associated with social capital of a user's profile on a website, wherein the social capital is based at least in part on a social network mapped on the website and including the user's profile;
attributing a value to the social capital based on at least one parameter associated with one or more characteristics of the social network;
providing, on the website, a protected space associated with the user's profile, wherein the protected space is controlled by a control entity other than the user and is configured to present verified indicia of the social capital.

8. The one or more computer readable media of claim 7, wherein verifying comprises confirming one or both of the accuracy and authenticity of the indicia.

9. The one or more computer readable media of claim 7, wherein verifying comprises confirming an identity of a party providing the indicia for presentation on the protected space.

10. The one or more computer readable media of claim 7, wherein the one or more social network characteristics describes at least one of:
a structure of the social network;
individual relationships between members of the social network;
a level of communicative activity between members of the social network; or
one or more attributes of individual members of the social network.

11. The one or more computer readable media of claim 7, further comprising tracking usage of the social capital as social collateral.

12. The one or more computer readable media of claim 7, wherein the verified indicia of the social capital comprises one or more of:
a symbol from a party other than the user;
a text message from the party other than the user; or
a representation of an extent by which the social capital has been used as social collateral.

13. The one or more computer readable media of claim 7, further comprising limiting access of the protected space to authorized entities identified by the control entity.

14. A method comprising
tracking usage of social capital as social collateral, wherein the social capital is associated with a user profile belonging to a social network mapped on a website, and wherein the social capital is based at least in part on one or more characteristics of the social network; and
presenting, on the website, a protected space associated with the user profile, wherein the protected space is controlled by an entity other than a user associated with the user profile and is configured to present verified indicia of the usage.

15. The method of claim 14, further comprising attributing a first value to the social collateral.

16. The method of claim 15, wherein the tracking comprises subtracting a second value from the first value to derive a remainder value, wherein the second value comprises a portion of the first value used as social collateral; and wherein the remainder value comprises an available social collateral.

17. The method of claim 16, wherein the verified indicia of the usage comprises one or more of: the first value, the second value, or the remainder value.

18. The method of claim 14, further comprising limiting access to the protected space to authorized entities.

19. The method of claim 14, wherein the website comprises a social networking website configured to digitally map the social network.
